(19) United States
(12) Patent Application Publication
(10) Pub. No.: US 2007/0149752 A1
(43) Pub. Date: Jun. 28, 2007

(54) Railway freight car constant contact side bearing

(76) Inventors: James S. Kennedy, Zelienople, PA (US); Richard L. Palinkas, Northfield, CT (US)

Correspondence Address: BUCHANAN INGERSOLL & ROONEY PC, P.O. BOX 1404, ALEXANDRIA, VA, 22313-1404, US

(21) Appl. No.: 11/633,731

(22) Filed: Dec. 5, 2006

Related U.S. Application Data
(60) Provisional application No. 60/742,948, filed on Dec. 6, 2005.

(51) Int. Cl. C08G 18/00

(52) U.S. Cl. 528/76

(57) ABSTRACT

A constant contact side bearing (CCSB) for insertion between a railroad car body and a wheeled truck supporting said car body is provided herein. It includes a housing and at least one resilient member. The resilient member is a polyurethane elastomer that may include polyether and/or polycaprolactone.

### CROSS-REFERENCE TO RELATED APPLICATIONS

This application claims priority to pending U.S. Provisional Patent Application No. 60/742,948, filed on Dec. 6, 2005. That application is incorporated by reference herein in its entirety.

### BACKGROUND OF THE INVENTION

The following includes information that may be useful in understanding the present inventions. It is not an admission that any of the information provided herein is prior art, or material, to the presently described or claimed inventions, or that any publication or document that is specifically or implicitly referenced is prior art.

1. Field

Embodiments of the present invention relate to, but are not limited to, the fields of side bearings for railroad cars. Particular embodiments relate to constant contact side bearings.

2. Background

A constant contact side bearing, hereinafter referred to as “CCSB,” is a device for limiting undesirable motion in railroad freight cars. A CCSB typically includes a contained resilient member (i.e. elastomer, spring, etc.) attached to the truck that maintains engagement with the freight car body. A wear cap on the CCSB typically contacts a wear plate on the freight car body. When the car experiences roll motion due to curving or track irregularities, the CCSB dissipates the resulting energy through vertical compression of the resilient member, restoring the system to equilibrium. In addition, the CCSB is capable of controlling hunting by resisting rotation of the truck via frictional sliding between the freight car body wear plate and the CCSB.

By reason of the operating conditions and environment that it experiences, the CCSB should be capable of providing good performance at both low and high temperatures. Low temperatures often result from ambient conditions, and high temperatures are attributed to the frictional heat generated at the interface between the wear cap and wear plate. The ability to achieve good low temperature performance has always come at the expense of reducing beneficial high temperature properties and decreasing beneficial mechanical properties such as fatigue life. Good high temperature performance has long come at the expense of performance at low temperature. This compromise in performance optimization has long presented a challenge to the industry.

Several approaches have been used to overcome this issue and the tradeoffs associated with it. Ideally, a CCSB should withstand the rigors of high and low temperatures, as well as millions of cycles of compression and relaxation, without substantial degradation of properties. Numerous elastomer and metal spring devices have been used in an attempt to best meet these needs. One such elastomer that has been used is a polyether-polyester thermoplastic block copolymer. Hytrel, from DuPont, is an example of such a block copolymer. While this material has fair performance in a CCSB, it is highly desirable to have an elastomer with both improved high temperature properties, and less loss of preload after cycling.

One elastomer that has demonstrated its ability to provide improvements in these areas is a high performance polyester polyurethane. However, it has been found that CCSBs produced from such an elastomers have not been adequate performers at low temperature, resulting in preloads that are too high at low ambient temperatures (see FIG. 2). Some CCSB designs have utilized elastomeric materials that focused on improved high temperature characteristics (refer to U.S. Pat. No. 6,092,470 and or U.S. Pat. No. 3,957,318). Other CCSB products have implemented elastomeric materials that have excellent low temperature properties and have tried to compensate for the degradation in high temperature performance by using insulators or convection with increased surface area (refer to U.S. Pat. No. 6,092,470 and or U.S. Pat. No. 6,862,999). Finally, some CCSB concepts have eliminated the use of elastomeric springs altogether, employing a metallic compression spring, but this tends to degrade the vertical damping characteristics and potentially reduces the fatigue life properties that are so critical to the CCSB performance (refer to U.S. Pat. No. 4,130,066 and U.S. Pat. No. 6,644,214).

There remains a need in the art to provide a CCSB with advantageous performance characteristics at both high and low temperatures while maintaining good fatigue life and vertical damping characteristics.

### BRIEF SUMMARY OF THE INVENTION

Embodiments provided herein may be a constant contact side bearing for a railway freight car mounted on a railway freight car body and a wheeled truck supporting said railway freight car body, comprising a housing and at least one resilient member disposed within the housing and configured to apply a pressure to a railroad car body, wherein each such resilient member is a polyurethane elastomer, and wherein said elastomer is a polyurethane elastomer comprising diphenyl methane diisocyanate (MDI), a polyol, and, a diol chain extender.

In some embodiments, MDI is selected from pure diphenyl methane diisocyanate, or an isomeric mixture of diphenyl methane diisocyanate. The isomeric mixture of diphenyl methane diisocyanate may comprise, for example at least one member of the group consisting of the 4,4′-MDI isomer, the 2,4′-MDI isomer, and the 2,2′-MDI isomer.

In some embodiments the polyol is selected from polyether and polycaprolactone. The polyol may have a glass transition temperature (Tg) below about 10° C., below about −40° C., and/or below about −60° C. The polyol may be, for example, but is not limited to a polyether diol selected from polytetramethylene ether (PTMEG), polyethylene ether glycol, polypropylene ether glycol, and polypropylene ether glycol-polyethylene ether glycol copolymers.

The diol chain extender may be, for example, but is not limited to of 1,4 butanediol, 1,3 butanediol, ethylene glycol, propylene glycol, diethylene glycol, dipropylene glycol, tripropylene glycol, pentanediol, hexanediol, methyl-pentanediol, octanediol, dodecanediol, cyclohexanediol, hydroxyethyl hydroquinone (HQEE), and hydroxyethyl resorcinol.

Embodiments may have one or more of various beneficial properties. For example, in some embodiments the vertical load at 5.0625 inches setup height is less than 10 kips for temperatures of at least about −20° F. In some embodiments the ratio of the preload following one vertical cycle to the preload following 1,000,000 vertical cycles is not greater than about 6.6:3.6. In some embodiments the change in the vertical load at 5.0625 inches setup height between about 60° F. and about 20° F. is less than 20%. In some embodiments the energy dissipation each vertical cycle from free height to solid height is greater than 5%.

In some embodiments a wear cap disposed between said resilient spring member and the car body is provided. In some embodiments the CCSB is an extended travel side bearing.

Embodiments of the invention may further provide a polyurethane elastomeric resilient railway freight car constant contact side bearing spring comprising a railway car resilient spring member comprising diphenyl methane diisocyanate (MDI), a polycaprolactone; and a diol chain extender selected from the group consisting of 1,4 butanediol, 1,3 butanediol, ethylene glycol, propylene glycol, diethylene glycol, dipropylene glycol, tripropylene glycol, pentanediol, hexanediol, methyl-pentanediol, octanediol, dodecanediol, cyclohexanediol, hydroxyethyl hydroquinone (HQEE), and hydroxyethyl resorcinol.

### BRIEF DESCRIPTION OF THE SEVERAL VIEWS OF THE DRAWINGS

FIG. 1 shows perspective, top and cross section views of an embodiment of a CCSB as described herein.

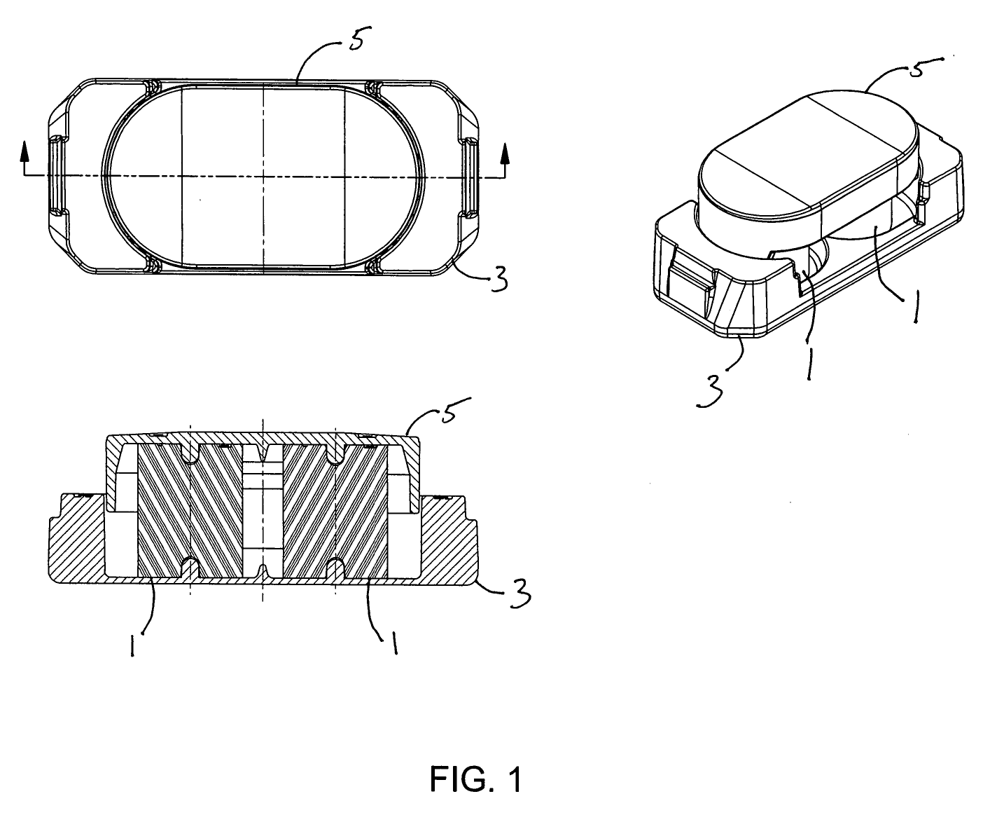

FIG. 2 is a graph comparing preload vs. temperature for a typical elastomer vs. a polycaprolactone polyurethane material for a constant contact side bearing application.

FIG. 3 is a graph of preload vs. vertical cycles for a typical elastomer vs. a polycaprolactone polyurethane material for a constant contact side bearing application.

FIG. 4 is a graph showing an energy dissipation comparison of a CSB column vs. a mechanical spring.

FIG. 5 illustrates perspective, top, and sectional views of a CCSB as described herein.

FIG. 6 shows perspective, top, and cross section views of a CCSB as described herein.

FIG. 7 illustrates perspective, top and sectional views of a CCSB as described herein.

FIG. 8 illustrates perspective, top and sectional views of a CCSB as described herein.

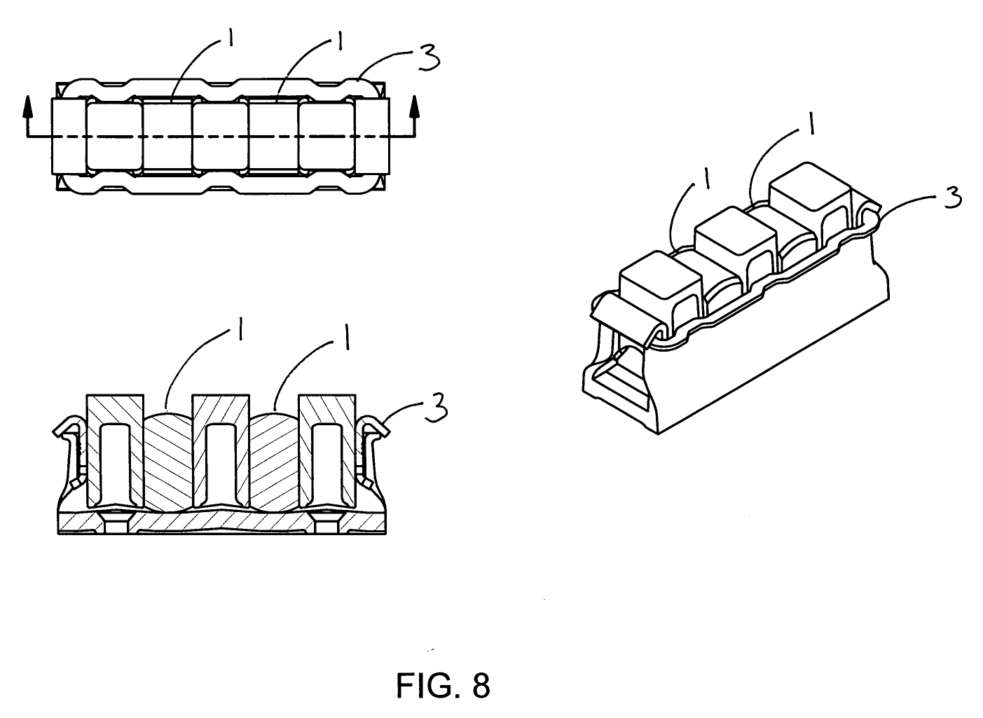

### DETAILED DESCRIPTION OF THE INVENTION

Embodiments presented herein provide a CCSB including a resilient member made of a polyurethane elastomer as taught herein. In some embodiments, the polyurethane elastomer is a polycaprolactone polyurethane elastomeric (“PPE”) material. In others it is a polyether polyurethane elastomeric material. By utilizing a spring made of polycaprolactone polyurethane elastomer material, one is able to achieve improvement in low temperature, high temperature, and fatigue life characteristics of the CCSB, while maintaining its advantageous vertical damping characteristics.

Polyurethane elastomers taught herein comprise the reaction products of diphenyl methane diisocyanate (MDI), a suitable polyol, and a diol chain extender. The diol chain extender may be a low molecular weight diol chain extender, with a molecular weight between about 60 to about 500. The MDI and polyol are typically pre-reacted to form a polyurethane prepolymer. One suitable polyurethane prepolymer is the commercially available VIBRATHANE® 8031 from Chemtura Corporation. Another is VIBRATHANE® 8030, also from Chemtura Corporation. Alternatively, a portion of the polyol can be reacted with a large excess of MDI to form a quasi-prepolymer. In a further alternative, the three ingredients can be mixed and reacted simultaneously in a one-shot system. As set forth below, other additives may also be incorporated into the elastomers.

MDI may be pure diphenyl methane diisocyanate, or an isomeric mixture. An isomeric mixture may comprise, for example, the 4,4′-MDI isomer and other isomers such as, for example, the 2,4′-MDI isomer and/or the 2,2′-MDI isomer.

It has been found that by utilizing a polyether or polcaprolactone polyurethane formulation, a CCSB can be produced that has acceptable low temperature preload. Suitable polyols include, for example, polyether polyols and polycaprolactone polyols with glass transition temperature (Tg) below 10° C. Such polyols often have Tg of −40° C. or less, with some polytetramethylene ether (PTMEG) glycols reaching below −60° C. Useful polyether diols include PTMEG, polyethylene ether glycol, polypropylene ether glycol, polypropylene ether glycol-polyethylene ether glycol copolymers, and the like with the preferred polyether diol being PTMEG.

Diol chain extenders useful herein include linear and cyclic aliphatic, and aromatic containing diols. Examples of such diols include 1,4 butanediol, 1,3 butanediol, ethylene glycol, propylene glycol, diethylene glycol, dipropylene glycol, tripropylene glycol, pentanediol, hexanediol, methyl-pentanediol, octanediol, dodecanediol, cyclohexanediol, hydroxyethyl hydroquinone (HQEE), and hydroxyethyl resorcinol. The preferred diol chain extenders are HQEE and 1,4 butanediol.

Various other additives can also be employed in preparing the polyurethane elastomer of this invention. These include, for example, but are not limited to, plasticizers such as dioctyl phthalate and tributoxyethyl phosphate, which can be added to lower cost and/or improve the physical properties of the elastomer. Dyes can be added for color. In addition, pigments, antioxidants, antiozonants, UV stabilizers, and the like, can also be added in the customary amounts.

One preferred polyether is PTMEG, which provides improved physical properties compared to other polyethers. Another preferred polyol is polycaprolactone. CCSBs produced from MDI-polycaprolactone and cured with a diol chain extender may provide excellent low temperature properties. These properties may be provided without compromising resistance to cyclic stress or high temperatures. In fact, the CCSBs produced using this polyurethane elastomer have surprisingly demonstrated further improvement in high temperature resistance. Also, typically CCSB of the invention do not require additional thermal barriers, though such may be added if desired.

Use of the prepolymer method for producing the polyurethane elastomer is preferred. This produces polyurethane elastomers with improved properties and reduced variability. Once formed, the prepolymer can then be mixed with diol chain extender and, optionally, other ingredients. Some possible optional ingredients include, for example, catalysts and pigments. This mixing can be done by hand, in a batch process, or continuously, using a meter-mix machine. The mixture is then poured into a pre-heated mold with the desired shape, and allowed to gel into an elastomer. Once sufficiently strong to withstand handling without damage, the part can be demolded. It is then optionally heated for an extended period of time to complete the chemical reaction and develop toughness. Typically, such cure temperatures range from 70° C. to about 120° C. or more. In a preferred embodiment, the cure temperature is between about 240° F. (about 115° C.) to about 260° F. (about 127° C.). Curing time will vary depending on catalyst used, curing temperature, and other factors. In one embodiment, the initial curing takes about 24 hours. Optionally, a further period of time at room temperature is often used to complete the development of the best physical properties. This optional second curing may be conducted, for example, at between about 60° F. (about 15° C.) and about 110° F. (about 43° C.) for about 15 to about 25 days.

CCSBs as taught herein may exhibit a variety of beneficial properties, as shown by the comparative examples set forth below and in the Figures. It should be noted, however, that these properties should not be construed as limitations on the invention as defined by the claims.

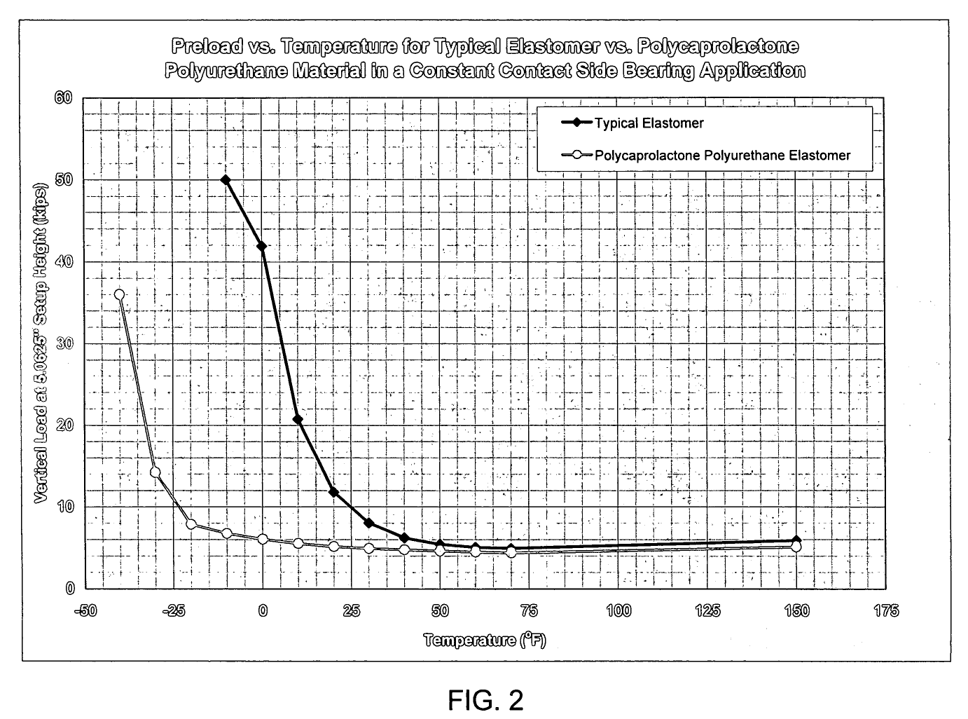

In a CCSBs as taught herein, the change in vertical stiffness from room temperature to the industry accepted metric of 20° F. (−6⅔ C.) remains essentially unchanged. As shown in FIG. 2, this represents an order of magnitude improvement in performance when compared to other side bearing technology.

CCSBs as taught herein may improve low temperature performance and enhance the high temperature performance. This is shown, for example, in FIG. 2. FIG. 2 compares a CCSB using current elastomer technology with a CCSB using polycaprolactone polyurethane elastomer technology in an industry accepted simulated service wear test regime that measures hunting resistance. The test used was the simulated service testing from specification M-948 for side bearing approval in the AAR Manual of Standards and Recommended Practices, which is incorporated by reference herein. Sustained temperatures of around 300° F. are achieved in this testing due to frictional heating at the interface between the wear cap and the wear plate.

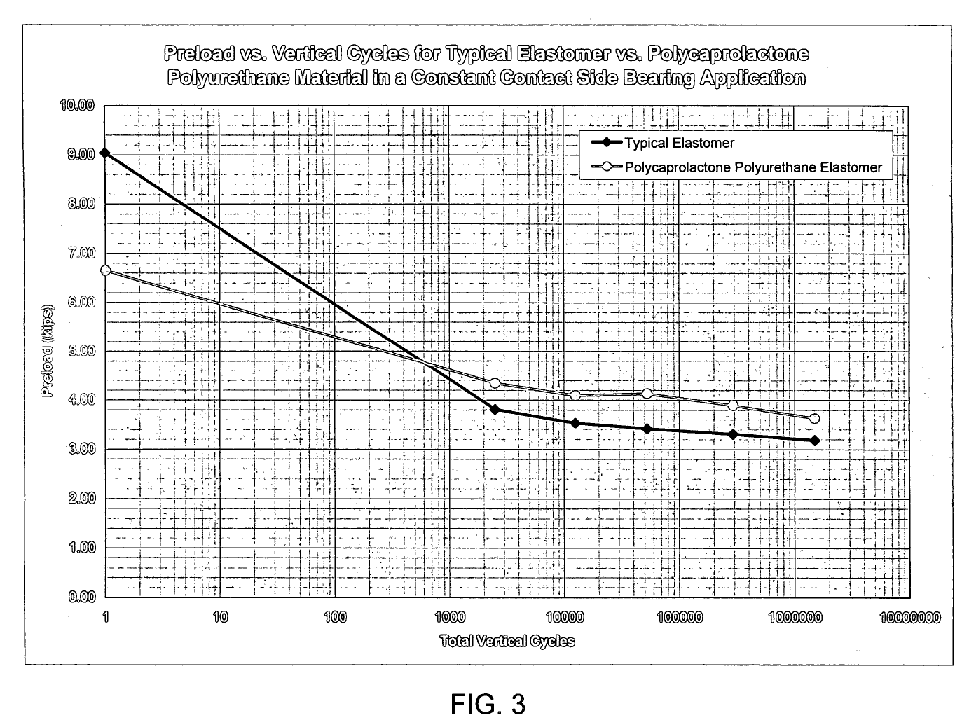

Fatigue life improvement is also achieved. FIG. 3 shows the enhanced preload retention traits of one embodiment after the vertical fatigue test from specification M-948 for side bearing approval in the AAR Manual of Standards and Recommended Practices.

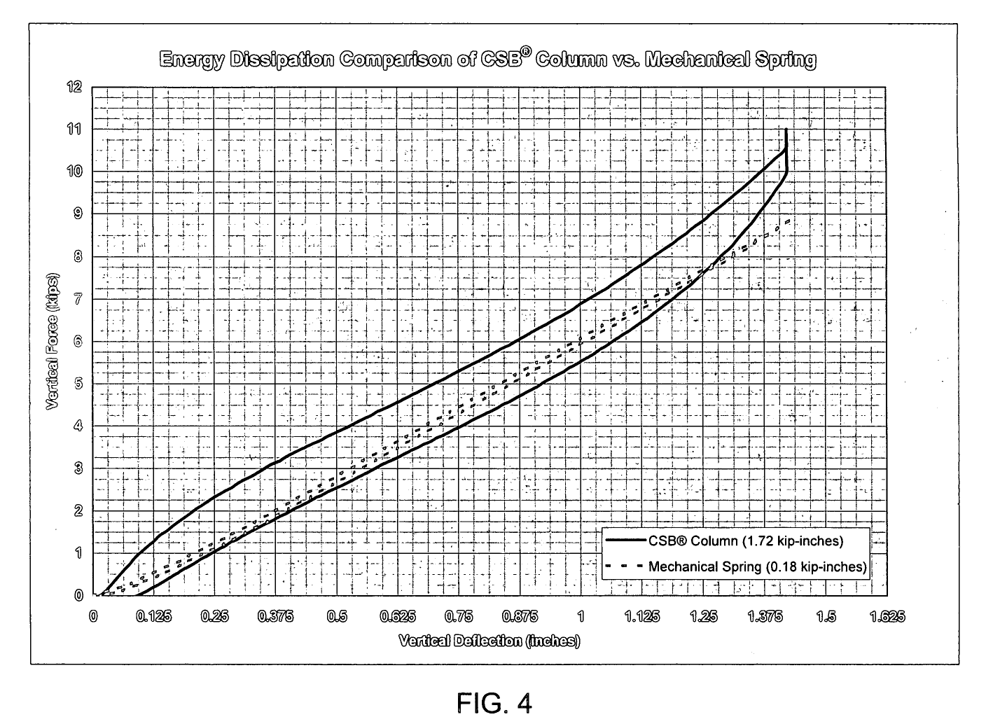

The low and high temperature performance of the CCSB is improved, while maintaining excellent vertical damping characteristics compared to a metallic compression spring. This is shown, for example, in FIG. 4.

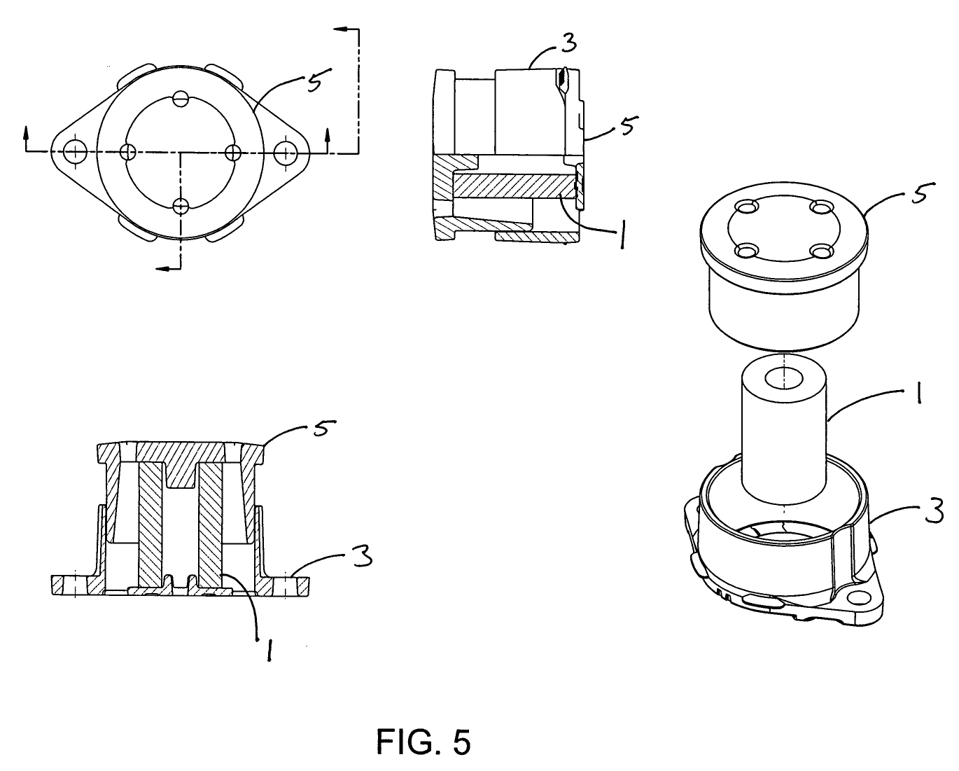

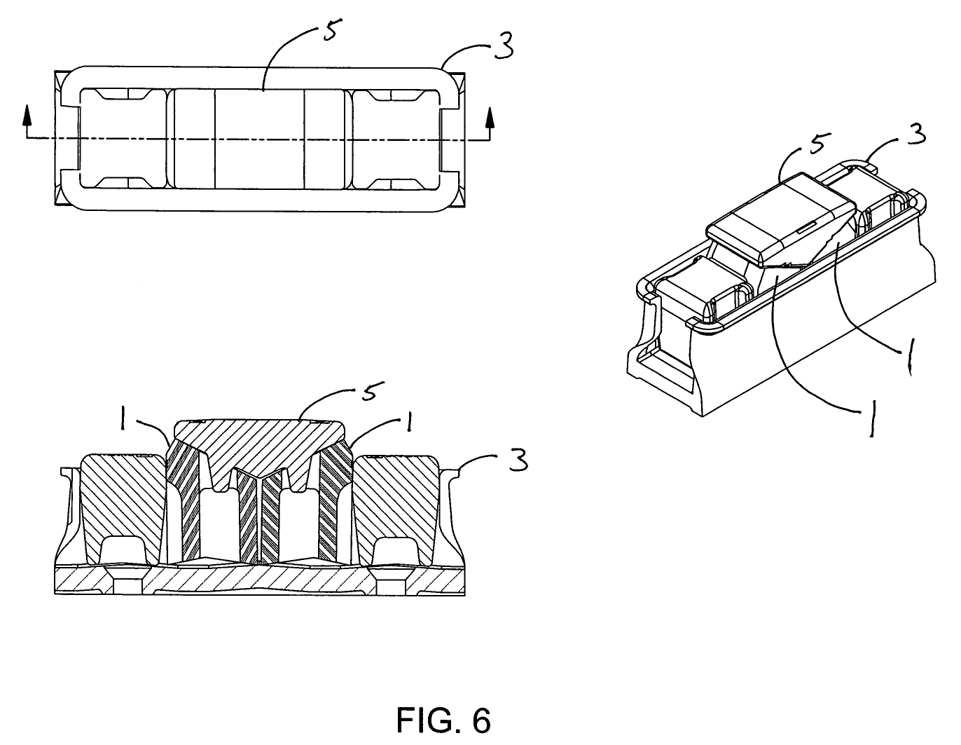

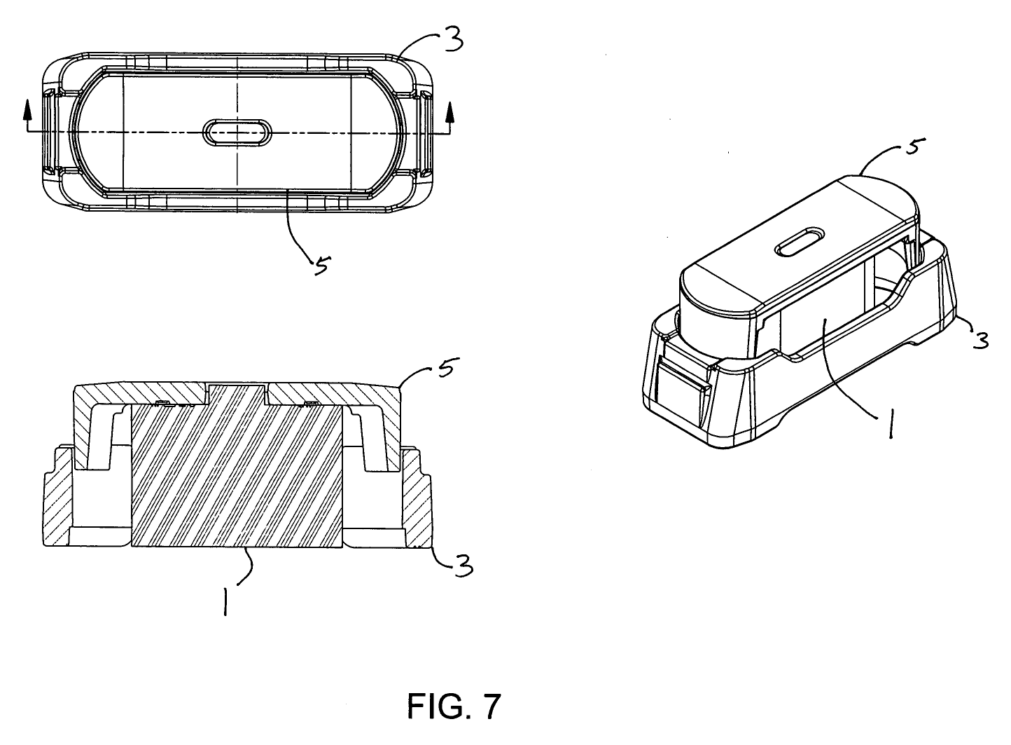

The benefits recited herein can be accomplished without the need for additional components or a major redesign in the CCSB assembly. FIGS. 5-7 show some embodiments for this design in which the elastomeric spring 1 is loaded primarily in compression between a housing 3 and a wear cap 5, although the benefits of the polyurethane elastomers taught herein are certainly not limited to these configurations and could be used in situations where the elastomeric spring are loaded in shear or tension. The benefits of the polyurethane material taught herein is most notable in long (extended) travel side bearings, but also works well for CCSBs with standard travel.

### EXAMPLES

The following example is intended to guide those skilled in the art in the practice of this invention. They should not be construed to limit the scope of the invention, which is defined by the claims.

### Example 1

### CCSB Molding Method with MDI Polycaprolactone Prepolymer

1 gal of VIBRATHANE® 8031, a commercially available MDI polycaprolactone prepolymer from Chemtura, was heated for 12 hours in a 70° C. oven to melt it. The % NCO (isocyanates) of the prepolymer was 6.7%. 700 g of this prepolymer was then weighed into a plastic beaker. Meanwhile, 112 g of HQEE was melted in a metal tin on a hot plate, at about 120° C.

The prepolymer was heated in a microwave to 90° C., and degassed by applying vacuum in a vacuum chamber. The HQEE was then also degassed in the vacuum chamber to be sure that the moisture content was low. After degassing, 108 g of HQEE were added to the Vibrathane while mixing, an amount sufficient to react with 98% of the available NCO. After thorough mixing, the mixture was returned to the vacuum chamber for a brief period of time to remove air bubbles, and then poured into a preheated (115° C.) metal CCSB mold. After about 5 minutes, the material had gelled to a soft solid state. After 60 minutes, the part was demolded without damage and returned to the 115° C. oven for a further 16 hrs. Upon removal from the oven, the part was allowed to continue postcuring at room temperature for a period of two weeks before any performance testing was performed.

All claims in this application, and all priority applications, including but not limited to original claims, are hereby incorporated in their entirety into, and form a part of, the written description of the invention. Applicants reserve the right to physically incorporate into this specification any and all materials and information from any such patents, applications, publications, scientific articles, web sites, electronically available information, and other referenced materials or documents. Applicants reserve the right to physically incorporate into any part of this document, including any part of the written description, and the claims referred to above including but not limited to any original claims. All patents and publications mentioned in this document are hereby incorporated by reference.

As used herein and in the appended claims, the singular forms “a,” “an,” and “the” include plural reference unless the context clearly dictates otherwise.

Subheadings herein are included for the benefit of the reader. They should not be used to limit the invention.

The terms and expressions employed herein have been used as terms of description and not of limitation, and there is no intention in the use of such terms and expressions, or any portions thereof, to exclude any equivalents now know or later developed, whether or not such equivalents are set forth or shown or described herein or whether or not such equivalents are viewed as predictable, but it is recognized that various modifications are within the scope of the invention claimed, whether or not those claims issued with or without alteration or amendment for any reason. Thus, it shall be understood that, although the present invention has been specifically disclosed by preferred embodiments and optional features, modifications and variations of the inventions embodied therein or herein disclosed can be resorted to by those skilled in the art, and such modifications and variations are considered to be within the scope of the inventions disclosed and claimed herein.

Specific methods and compositions described herein are representative of preferred embodiments and are exemplary and not intended as limitations on the scope of the invention. Other objects, aspects, and embodiments will occur to those skilled in the art upon consideration of this specification, and are encompassed within the spirit of the invention as defined by the scope of the claims. Where examples are given, the description shall be construed to include but not to be limited to only those examples. It will be readily apparent to one skilled in the art that varying substitutions and modifications may be made to the invention disclosed herein without departing from the scope and spirit of the invention, and from the description of the inventions, including those illustratively set forth herein, it is manifest that various modifications and equivalents can be used to implement the concepts of the present invention without departing from its scope. A person of ordinary skill in the art will recognize that changes can be made in form and detail without departing from the spirit and the scope of the invention. The described embodiments are to be considered in all respects as illustrative and not restrictive. Thus, for example, additional embodiments are within the scope of the invention and within the following claims.

What is claimed is:

1. A constant contact side bearing for a railway freight car mounted on a railway freight car body and a wheeled truck supporting said railway freight car body, comprising:
(a) a housing;
(b) at least one resilient member disposed within said housing and configured to apply a pressure to a railway freight car body; and
(c) wherein said resilient member is a polyurethane elastomer further comprising:
(i) diphenyl methane diisocyanate;
(ii) a polyol; and
(iii) a diol chain extender.

2. The constant contact side bearing of claim 1, wherein said diphenyl methane diisocyanate is selected from the group consisting of pure diphenyl methane diisocyanate, or an isomeric mixture of diphenyl methane diisocyanate.

3. The constant contact side bearing of claim 2, wherein said isomeric mixture of diphenyl methane diisocyanate comprises at least one member of the group consisting of the 4,4′-diphenyl methane diisocyanate isomer, the 2,4′-diphenyl methane diisocyanate isomer, and the 2,2′-diphenyl methane diisocyanate isomer.

4. The constant contact side bearing of claim 1, wherein said polyol is selected from polyether and polycaprolactone.

5. The constant contact side bearing of claim 4, wherein said polyol has a glass transition temperature (Tg) below about 10° C.

6. The constant contact side bearing of claim 5, wherein said polyol has a Tg below about −40° C.

7. The constant contact side bearing of claim 6, wherein said polyol has a Tg below about −60° C.

8. The constant contact side bearing of claim 4, wherein said polyol is a polyether diol selected from the group consisting of polytetramethylene ether, polyethylene ether glycol, polypropylene ether glycol, and polypropylene ether glycol-polyethylene ether glycol copolymers.

9. The constant contact side bearing of claim 1, wherein said diol chain extender is selected from the group consisting of 1,4 butanediol, 1,3 butanediol, ethylene glycol, propylene glycol, diethylene glycol, dipropylene glycol, tripropylene glycol, pentanediol, hexanediol, methyl-pentanediol, octanediol, dodecanediol, cyclohexanediol, hydroxyethyl hydroquinone, and hydroxyethyl resorcinol.

10. The constant contact side bearing of claim 1, wherein said polyol is selected from the group consisting of polycaprolactone and polytetramethylene ether, and said diol chain extender is selected from the group consisting of 1,4 butanediol and hydroxyethyl hydroquinone.

11. The constant contact side bearing of claim 10, wherein said polyol is polytetramethylene ether and said diol chain extender is 1,4 butanediol.

12. The constant contact side bearing of claim 10, wherein said polyol is polytetramethylene ether and said diol chain extender is hydroxyethyl hydroquinone.

13. The constant contact side bearing of claim 10, wherein said polyol is polycaprolactone and said diol chain extender is hydroxyethyl hydroquinone.

14. The constant contact side bearing of claim 10, wherein said polyol is polycaprolactone and said diol chain extender is 1,4 butanediol.

15. The constant contact side bearing of claim 1, wherein the vertical load at 5.0625 inches setup height is less than 10 kips for temperatures of at least about −20° F.

16. The constant contact side bearing of claim 1, wherein the ratio of the preload following one vertical cycle to the preload following 1,000,000 vertical cycles is not greater than about 6.6:3.6.

17. The constant contact side bearing of claim 1, wherein the change in the vertical load at 5.0625 inches setup height between about 60° F. and about 20° F. is less than 20%.

18. The constant contact side bearing of claim 1, wherein the energy dissipation each vertical cycle from free height to solid height is greater than 5%.

19. The constant contact side bearing of claim 1, further comprising a wear cap disposed between said resilient spring member and said car body.

20. The constant contact side bearing of claim 1, wherein said constant contact side bearing is an extended travel side bearing.

21. A polyurethane elastomeric resilient railway freight car constant contact side bearing spring comprising:
(a) diphenyl methane diisocyanate;
(b) a polycaprolactone; and
(c) a diol chain extender selected from the group consisting of 1,4 butanediol, 1,3 butanediol, ethylene glycol, propylene glycol, diethylene glycol, dipropylene glycol, tripropylene glycol, pentanediol, hexanediol, methyl-pentanediol, octanediol, dodecanediol, cyclohexanediol, hydroxyethyl hydroquinone, and hydroxyethyl resorcinol.
